(19) United States
(12) Patent Application Publication
(10) Pub. No.: US 2009/0106131 A1
(43) Pub. Date: Apr. 23, 2009

(54) REMOTE RECORDATION OF FINANCIAL DATA USING A PERSONAL MOBILE DEVICE

(76) Inventors: Vahid Danesh-Bahreini, Bellevue, WA (US); Kaveh Danesh, Bellevue, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/174,597

(22) Filed: Jul. 16, 2008

Related U.S. Application Data
(60) Provisional application No. 60/950,082, filed on Jul. 16, 2007.

(51) Int. Cl. G06Q 10/00; G06F 15/16; G06F 17/30; G06F 17/40

(52) U.S. Cl. 705/30; 709/204; 709/206; 707/100; 707/E17.009; 707/E17.031; 707/E17.101

(57) ABSTRACT

Systems and methods for processing financial transactions at remote locations on wireless communication devices is presented. A wireless communication device is configure with executable modules such that the device can interact with a user to, first, receive a first user indication to create a data record corresponding to a financial transaction on the wireless communication device. Thereafter, the device creates a data record corresponding to the financial transaction. Information corresponding to the financial transaction on the wireless communication device is received into a data record and stored in a temporary data store on the wireless communication device. Thereafter, the wireless communication device transmits the data record to a receiving service for processing in a financial application.

### CROSS-REFERENCE TO RELATED APPLICATION

This application is a nonprovisional of U.S. Provisional Application No. 60/950,082, filed Jul. 16, 2007, the entire disclosure of which is hereby incorporated by reference herein.

### BACKGROUND

In a world where the art of technology is actively and favorably affecting various parts of our lives, it becomes necessary to apply this revolutionary art to all aspects of the progressive lifestyle. Specifically, the financial realm of people's lives has recently received little of technology's attention—Yes, there are some programs meant to facilitate and advocate increased financial management such as SAP®, QuickBooks®, Microsoft Money®, Quicken®, and Peachtree®—but in no way have these applications been upgraded to meet the standards of other aspects of our lives.

These aforementioned aspects are often vital to society's success; conversely, they may sometimes be auxiliary indulgences used solely for entertainment purposes. An example would be the notorious iPod®, which has received much attention in recent years. From October 2001 to January 2007, seven distinct generations have been released, each with a new, innovative addition, whether it be additional storage space, a color screen, or video capabilities.

On the contrary, QuickBooks, the leading financial management software in the United States, has yet to take full advantage of the recent boom in technology since its debut in 1992. Similarly, the world's first accounting software, Peachtree, has only updated its application by releasing new versions.

In the current United States, poverty has become a primary concern for its citizens—In 2006, approximately 13 percent of all U.S. citizens fell under the poverty threshold. This was an abrupt and undoubtedly unfavorable change, as in 2000 only 11.3 percent were considered to be “poor.” Much of this increase in destitution can be attributed to poor management of money, as it is tough for many to juggle the different expenditures—food, clothing, rent, etc.—and to thereby balance them with an income.

The logical conclusion, therefore, would be to take advantage of the recent expansion of technology, and to directly apply it to the waning state of finance. In essence, a combination of these currently antipodal worlds can only result in an advantageous outcome.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 demonstrates an illustrative environment in which aspects of the disclosed and claimed subject matter may operate, including personal wireless communication devices in communication with a wireless service which is further coupled to a receiving server over a network connection;

FIG. 2 is a block diagram that demonstrates components (both logical and actual) of an illustrative personal wireless communication device suitable for implementing aspects of the disclosed and claimed subject matter;

FIG. 3 is a block diagram that demonstrates components (both logical and actual) of an illustrative receiving computing device suitable for implementing aspects of the disclosed and claimed subject matter; and

FIG. 4 illustrates a flow diagram for general entry and processing of financial/transaction information on a personal wireless communication device.

### DETAILED DESCRIPTION

Disclosed is a system and method for financial management including an application for use with mobile devices, especially wireless phones and hybrid phone/PDA devices. Examples include, by illustration and no by limitation, RIM's Blackberry® devices, Apple's iPhone®, and the like. In addition to providing a tool to manage finance combined with the freedom of a cell phone, the disclosed subject matter provides for the wireless transfer of the client's financial information to other devices including servers, desktops, and laptops, thereby increasing the possibilities and likelihood of appropriate financial management of expenditures and the like.

Another aspect of the disclosed subject matter that will vastly affect the financial world is the transfer of information of financial information to various destinations via email. For example, using the disclosed systems and methods, employees will be enabled to instantly send information (such as expenditures) and/or reports to their company's headquarters with the click of a button. This information can be in the form of tables, charts, or diagrams, and can be presented by category, date, or time period. With this variety of options, clients and corporations will be more aware of, for example, which expenses are overly exorbitant and need attention, or the time of month at which spending a bit of extra money on a nice dinner wouldn't hurt.

The systems and methods allow for inputs for various categories, including expenses and incomes. Upon receiving either, the client can immediately enter the amount in the appropriate date and category, be it transportation, taxes, or food. Later, a report (suitable for the device upon which the client is using) can be viewed to see where a majority of money was spent, or whether or not the income will be able to cover the expenditures. Similarly, various reports can be generated on those services or other computing systems that receive the information from the client's device.

According to aspects of the disclosed subject matter, both personal and business categories can be supported, thereby separating the two distinct categories. The client would therefore be able to avoid sending personal financial information to his/her managing company. Of course, it should be appreciated that there could be, theoretically, any number of categories to which the user may direct financial information. Thus, discussion of two categories should be viewed as illustrative and not limiting upon the disclosed subject matter.

The wide base of people that would be affected by the invention is a critical aspect of its distinctiveness. In today's world, people of all varieties are well-acquainted with technology—from the curious eight year old to the sagacious grandfather, almost all members of society own the seemingly essential technologies like the cell phone. Therefore, people of all ages and situations would benefit from the disclosed subject matter; the young girl can find the best way to spend her allowance just as the jaded adult can balance his/her incomes and expenses.

Problems with memory space and features are inevitable to emerge with mobile devices. However, the invention's back-end capabilities are an effective way to solve this problem: By having the option of transferring financial information to a desktop, laptop, or server, a client will always be able to manage his/her financial world most effectively while also keeping sufficient storage space on a cell phone.

Yet another aspect of the disclosed subject matter includes high configurability with regard to uploading information to a server (or other computing device configured to receive. For example, the software application that resides on the cell phone (or other communication device) may be configured to automatically initiate an upload of the financial information to the receiving server when the memory usage for the financial information reaches a threshold amount of the total capacity allotted to store the financial information. Alternatively, the software application may be configured to upload the financial information in an on-demand manner according to user directives, or to automatically upload the information at a certain time of day and/or when the rates for transmitting the financial information may be lowest. Still further, the software application may be configured to upload the financial information as it is entered such that the receiving host can have real-time updates of financial expenditures. Of course, in addition to uploading information over the wireless phone network, the software may be configured to upload the information via a direct line (such as via a USB or FireWire connection) if the user would prefer.

While many hand-held wireless phones now include keypads that enable a user to enter text information relatively easily, not all users will have such capabilities or want to enter a lot of financial information in that manner. Accordingly, the software may be configured to permit the user to enter entirely text based information, a combination of text and voice annotations, or voice information. As an example of a combination, a user may make an entry with an amount (say of dinner) and then provide a voice annotation as to the purpose and attendees of the dinner such that both the text-entered amount and the voice annotation are uploaded to the receiving server.

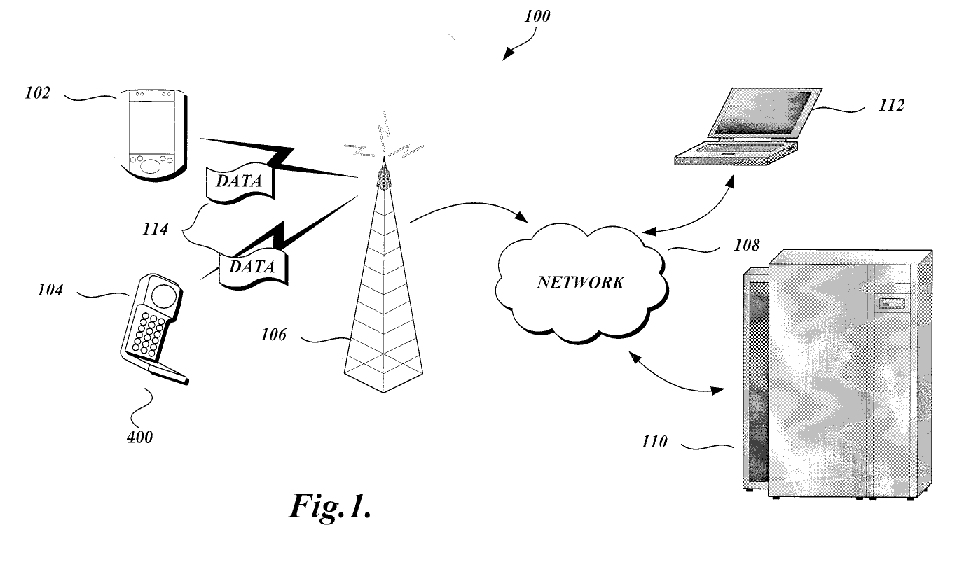

Regarding FIG. 1, this pictorial diagram demonstrates an illustrative network environment 100 in which aspects of the disclosed and claimed subject matter may operate, including personal wireless communication devices 102 and 104 in communication with a wireless service 106 which is further coupled to a receiving server 108 over a network 110. Also shown in the illustrative network environment 100 is a personal computing device 112, illustrated as a laptop but which may be any type of computing device. The personal computing device 112 corresponds to a user's computer where accounting and/or financial software would typically be maintained.

According to aspects of the disclosed subject matter, a user can record financial information on a personal wireless communication device at a remote location, such as the wireless telephone/PDA combination 102, transmit the data 114 over the wireless service 106 and network 108 to a receiving server 110, an online storage service (not shown), or the user's computing device 112.

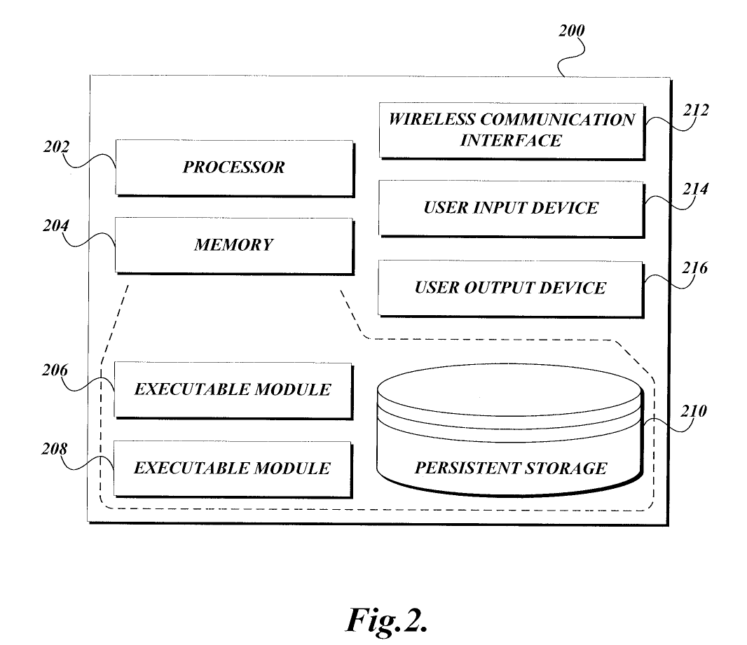

Turning to FIG. 2, this figure is of a block diagram that demonstrates components (both logical and actual) of an illustrative personal wireless communication device 200 suitable for implementing aspects of the disclosed and claimed subject matter. The wireless communication device 200 includes a processor 202 that executes computer executable instructions from a memory 204. Those skilled in the art will appreciate that the memory 204 may include read-only memory (ROM), random-access memory (RAM), persistent data storage 210, flash memory devices, and the like. The memory 204 stores executable modules 206 and 208 that may be executed by the processor 202 to carry out various functions for gathering, categorizing, and transferring financial information/data from a user to an external receiving service, server 110, and/or computer 112.

The personal computing device 200 typically includes one or more user input devices, such as user input device 214, by which a user interacts with the personal computing device to enter financial information. Examples of such user input devices includes a keypad, a touchpad, a camera, and the like. The personal computing device 200 further typically includes at least one user output devices, such as user output device 216. As those skilled in the art will appreciate, an exemplary user output device is an LCD screen upon which information may be displayed. In some cased, the user output device 216 may be a speaker on the user's personal wireless communication device 200 where all output is audio output.

Further illustrated in the personal wireless communication device 200 is a wireless communication interface 212. Wireless communication interfaces are well known in the art, and may use a variety of communication technologies including, but not limited to TDMA, GSM, UMTS, Wi-Fi, Wi-Max, CDMA-2000, Bluetooth, Edge, 802.11 protocols, IR, and the like. While not illustrated, the personal wireless communication device 200 may further include a wired communication interface, such as a USB communication port, Firewire port, parallel port, serial port, and the like. Using the wired communication interface, a user may cause the personal wireless communication device 200 to upload data temporarily stored on the personal wireless communication device directly to the user's computer 112.

One of the many advantages of the disclosed subject matter is that the data records that are generated for each financial transaction entry may be placed in any number of formats and/or prepared for any number of financial systems. For example, the data records may be formatted according to general ledger and accounting standards such that the records transmitted to receiving servers can be automatically (rather than manually, as is the current practice) incorporated into a business's finance system. Alternatively, the output may be configured to comply with the formats required for personal finance software such as Quicken. Additionally, the data record may be converted into a tab-delineated, text based document and emailed to a particular address. Given that the format of the data record corresponding to the financial transaction is know, information from the record can be automatically extracted and fed into charts, spreadsheets, and the like. Categorizing each entry can be used to determine the output of the system.

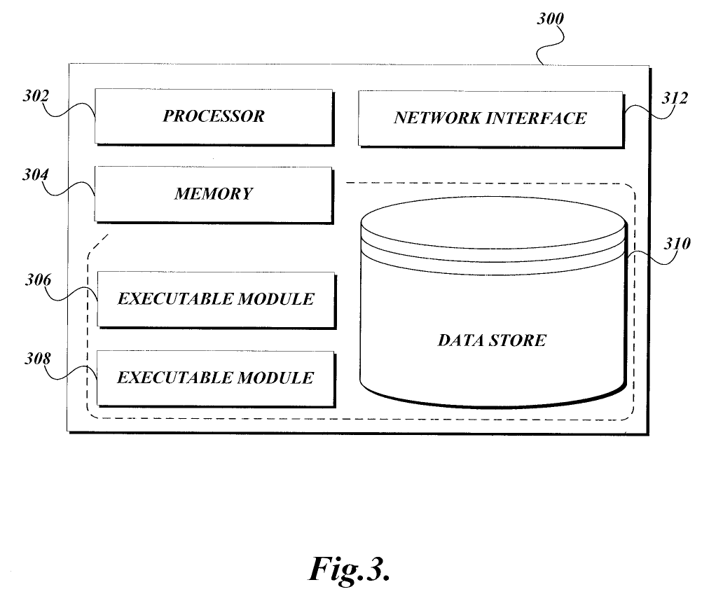

Turning now to FIG. 3, this figures is of a block diagram of an illustrative receiving computing device 300 suitable for receiving and processing financial data from a personal wireless communication device 200. The receiving computing device 300 includes a processor 302 that executes computer executable instructions retrieved from a memory 304. As discussed above, those skilled in the art will appreciate that the memory 304 may include read-only memory (ROM), random-access memory (RAM), persistent data storage 310, flash memory devices, and the like. The memory 304 stores executable modules, such as executable modules 306 and 308, that are executed by the processor 302 to carry out various functions for gathering, categorizing, and storing finance data received from a user's wireless communication device 200.

FIG. 3 is further illustrated as including a network interface that enables the receiving computing device 300 to connect to a network, such as the Internet, for receiving user finance data. While not shown, the receiving computing device 300 may also include a wireless communication interface which, like the user's personal communication device 200, sends and receives data wirelessly, including finance data.

As is well appreciated, not all personal wireless communication devices include keypads that enable a user to enter robust finance information. For example, a wireless telephone may include a 10-key numeric keypad that could be used to enter alphabetic and numeric characters. Of course, a user would find entering complete finance detail of a transaction into the wireless device to be onerous and, therefore, would not make use of the option to do so. On the other hand, a wireless telephone is well suited to receiving voice signals and, when coupled with some simple buttons presses on the wireless telephone, could store robust finance information regarding a business or personal expense. For example, after a business meal, the user may activate a program on the wireless communication device 200 to enter finance information, press a few simple buttons and/or select menu items that may include general ledgers and accounting standards to indicate whether this new entry is personal or business, that it is for a meal, and then provide an audio description of the cost by speaking into the device (while it records), enumerate the people at the meal, indicate the subject matter that was discussed, and (either by voice or by keypress) temporarily store the finance entry on the telephone (for later processing.) Still further, when the telephone is equipped with a camera, the user may also attach one or more images of the receipt to the financial entry.

As mentioned above, the personal wireless communication device 200 may be configured to transfer the finance information temporarily stored on the computing device in an on-demand manner, when a storage threshold is exceeded, at a specific time of day, only when current power reserve levels exceed a predetermined threshold, according to specific user instructions, and the like as well as various combinations of the above.

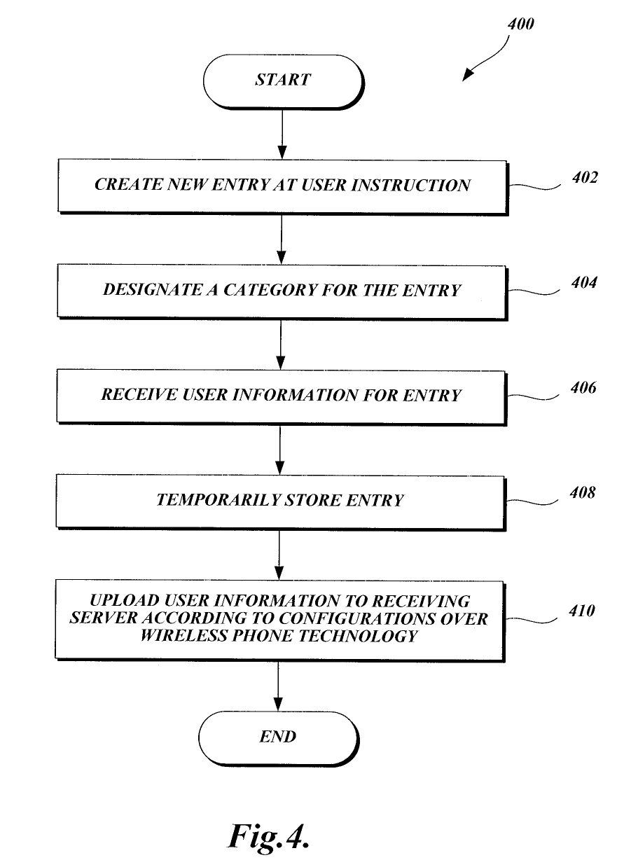

Turning now to FIG. 4, this figure is of a flow diagram illustrating a routine 400 for general entry and processing of financial/transaction information on a personal wireless communication device 200. At block 402, the user initiates creation of a new financial entry. The user may do this through a variety of user interactions available for the particular wireless communication device, such as but not limited to a selection of a menu, pressing a particularly configured button, and the like.

At block 404, the user optionally identifies a category for the financial entry. For example, the category may be for a personal expense, a business expense, general ledgers and accounting standards, and the like. Thereafter, at block 406, the personal wireless communication device 200 receives the financial data from the user. As already indicated, the user may input information regarding the particular financial entry by way of keypad, voice annotation, pictures and/or video, via a stylus on a touch or pressure sensitive touchpad, or combinations of the above.

After entering the information, at block 408, the financial data associated with the entry is stored in temporary storage for later transmittal to the user's computer, a receiving service or server, or the like. At some point thereafter (whether by periodic updates, at the direction of the user, when a storage threshold is reached, or the like), at block 410 the entry is uploaded to a receiving computer and/or service where the user can further process the information. Thereafter, the routine 400 terminates.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for processing financial transactions at remote locations by a wireless communication device, the method comprising:
receiving a first indication to create a data record corresponding to a financial transaction on a wireless communication device;
creating the data record corresponding to the financial transaction on the wireless communication device;
receiving information corresponding to the financial transaction on the wireless communication device;
storing the data record in a temporary data store on the wireless communication device; and
transmitting the data record to a receiving service for processing in a financial application.

2. The method of claim 1, wherein receiving information corresponding to the financial transaction on the wireless communication device comprises receiving audio input corresponding to the financial transaction on the wireless communication device.

3. The method of claim 1, wherein receiving information corresponding to the financial transaction on the wireless communication device comprises receiving an image corresponding to the financial transaction on the wireless communication device by way of a camera that is part of the wireless communication device input.

4. The method of claim 3, wherein receiving information corresponding to the financial transaction on the wireless communication device further comprises receiving audio input corresponding to the financial transaction on the wireless communication device

5. The method of claim 1 further comprising receiving a second indication as to a predetermined category corresponding to the financial transaction.

6. The method of claim 1, wherein transmitting the data record to a receiving service for processing in a financial application comprises transmitting the data record when a predetermined storage threshold has been reached on the wireless communication device.

7. The method of claim 1, wherein transmitting the data record to a receiving service for processing in a financial application comprises transmitting the data record at a predetermined time of day.

8. The method of claim 1, wherein transmitting the data record to a receiving service for processing in a financial application comprises transmitting the data record upon user initiation.

9. A wireless communication device for processing financial transactions at remote locations, the device comprising:
a processor;
a memory; and
a wireless communication interface;
wherein the memory stores an executable module which, when executed, configures the wireless communication device to:
receive a first indication from a user to create an data record corresponding to a financial transaction;
create the data record corresponding to the financial transaction;
receive information corresponding to the financial transaction and store the information in the created data record;
store the data record in a temporary data store on the wireless communication device; and
transmit the data record to a receiving service for processing in a financial application.

10. The wireless communication device of claim 9 further comprising an audio input component, and wherein receiving information corresponding to the financial transaction comprises receiving audio input corresponding to the financial transaction on the wireless communication device.

11. The wireless communication device of claim 9 further comprising a camera component, and wherein receiving information corresponding to the financial transaction comprises receiving an image corresponding to the financial transaction by way of the camera component.

12. The wireless communication device of claim 11 further comprising an audio input component, and wherein receiving information corresponding to the financial transaction further comprises receiving audio input corresponding to the financial transaction on the wireless communication device.

13. The wireless communication device of claim 9 further comprising a user input device, and wherein the wireless communication device is further configured to receive a second indication by way of the user input device identifying a predetermined category corresponding to the financial transaction.

14. The wireless communication device of claim 9, wherein transmitting the data record to a receiving service for processing in a financial application comprises transmitting the data record when a predetermined storage threshold for storing data records in a temporary data store on the wireless communication device has been reached.

15. The wireless communication device of claim 9, wherein transmitting the data record to a receiving service for processing in a financial application comprises transmitting the data record at a predetermined time of day.

16. The wireless communication device of claim 9, wherein transmitting the data record to a receiving service for processing in a financial application comprises transmitting the data record upon a third initiation.

17. A wireless communication device for processing financial transactions at remote locations, the device comprising:
a processor means;
a storage means for storing executable modules and data records corresponding to a plurality of financial records; and
a wireless communication means for communicating data records of financial transactions wirelessly to a receiving service;
wherein, upon execution of an executable module from the storage means by the processor means, the wireless communication device is configured to:
receive a first indication from a user via a user input means to create a data record corresponding to a financial transaction;
create the data record in the storage means;
receive information corresponding to the financial transaction and store the information in the created data record, the information comprising information in text form and at least one other form;
store the data record in a temporary data area in the storage means; and
transmit the data record to a receiving service for processing in a financial application.
